(19) United States
(12) Patent Application Publication
(10) Pub. No.: US 2007/0074073 A1
(43) Pub. Date: Mar. 29, 2007

(54) Detection system and method

(75) Inventors: Ping-Sheng Chen, Jhongpu Township (TW); Hong-Ching Chen, Fongshan City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Media Tek Inc.

(21) Appl. No.: 11/528,831

(22) Filed: Sep. 27, 2006

(30) Foreign Application Priority Data
Sep. 28, 2005 (TW) 094133659

(51) Int. Cl. G06F 11/00

(52) U.S. Cl. 714/11

(57) ABSTRACT

In a process for recording a data onto an optical storage medium which includes a fault correction mechanism, a detection system is preferably coupled to an optical data recorder comprising a data generating device and a data reading device. The data generating device generates the recorded data. The data reading device reads a reflection signal from the optical storage medium and generates a read-out signal to the determination device. A reflection signal is read from the medium to detect whether the recorded data can be reliably read out under this mechanism. A determination device of the detection system outputs a faulted data information signal in responsive to the reflection signal based on rules of the fault correction mechanism. The determination device further comprises a fault detection module. The fault detection module would receive the read-out signal and output a write fault signal as the faulted data information signal.

### BACKGROUND OF THE INVENTION

1. Field of the Invention

The present invention relates to a detection system and method, more particularly, to a detection system and method for detecting whether the data recorded onto the optical data storage medium can be reliably read out under a fault correction mechanism.

2. Description of the Prior Art

There are various types of rewrite discs nowadays, including compact disc rewritable (CD-RW), digital versatile disc rewritable (DVD+RW), DVD-random access memory (DVD-RAM), etc. When data are written onto these rewrite discs, in order to avoid data written on unreliable area of the disc and to ensure accessibility and reliability of the recorded data, a defect management method is developed. When data are to be recorded in a defect area, the defect management enables the data to be recorded in another area, called a spare area. That would avoid the data incompleteness or unreliability when accessing the data later.

The detection method of the prior-art usually employs the following steps to ensure the data validity: every time when all the data have been recorded on the disc and still remained in the recorder memory, reading all the recorded data and performing a “read verify” check. If inaccessible data are detected, re-writing the data to empty spare areas. Though the method described above can ensure the reliability of the recorded data, it needs not only more time for data recording but also for data reading and detection in order to complete the entire data recording operation. The prior-art would thus increase the total time for data recording. Furthermore, in order to ensure the data to be recorded still being resided in the recorder memory before complete the entire data recording operation, the data have to be separated into multiple smaller segments in response to the memory sizes. That will decrease the data recording efficiency.

In summary, the prior-art detection method during data recording has some problems: (1) the resolution and sensitivity in defect detection are insufficient; (2) there is no efficient means to tell whether the defect data can be reliably read out under a fault correction mechanism (also called error correction mechanism) only based on the defect data; (3) though the “read verify” check can solve the problems (1) and (2), it is not an efficient solution because of the time cost. Thus, the prior-art detection method for solving the data recording problems is not satisfactory.

### SUMMARY OF THE INVENTION

An objective of the present invention is to provide a detection system and method. When the data are recorded onto an optical data storage medium including a fault correction mechanism, a reflection signal is read from the optical data storage medium for detecting whether the recorded data can be reliably read out under the fault correction mechanism.

In a preferred embodiment, the detection system comprises a data generating device, a data reading device and a determination device. The data generating device generates the recorded data. The data reading device reads a reflection signal from the optical data storage medium and generates a read-out signal to the determination device. The determination device further comprises a fault detection module and outputs a faulted data information signal in responsive to the reflection signal based on rules of the fault correction mechanism. The fault detection module would receive the read-out signal and output a write fault signal as the faulted data information signal.

According to another preferred embodiment of the present invention, a detection method includes the following steps of: (I) reading the reflection signal and generating a radio frequency (RF) signal; (II) reading the reflection signal and outputting a data synchronization signal that synchronizes with the recorded data; (III) receiving the RF signal and outputting a write fault signal; and (IV) receiving the data synchronization signal, and outputting a faulted data information signal based on rules of the fault correction mechanism, the write fault signal and the data synchronization signal.

The detection system and method of the present invention reads the reflection signal from the optical data storage medium during the data recording process. Reading the reflection signal permits and facilitates a direct determination of the recorded data reliability. The efficiency and quality of the recorded data can be improved because it can save the time cost of reading the recorded data again in the prior-art.

### BRIEF DESCRIPTION OF THE APPENDED DRAWINGS

The advantage and spirit of the invention may be understood by the following recitations together with the appended drawings:

FIG. 1 is a functional block diagram of a detection system according to the present invention;

FIG. 2(A) is a schematic diagram of one kind of write fault signal generated by the detection system shown in FIG. 1;

FIG. 2(B) is a schematic diagram of another kind of write fault signal generated by the detection system shown in FIG. 1;

FIG. 3(A) is a schematic diagram of one kind of write fault signal generated in different manners based on the read-out signal by the detection system shown in FIG. 1;

FIG. 3(B) is a schematic diagram of another kind of write fault signal generated in different manners based on the read-out signal by the detection system shown in FIG. 1;

FIG. 4 is a schematic diagram of another kind of write fault signal generated based on the read-out signal by the detection system shown in FIG. 1;

FIG. 5 is a schematic diagram of another kind of write fault signal generated based on another read-out signal by the detection system shown in FIG. 1;

FIG. 6 is a schematic diagram of the buffer memory of the data generating device according to the present invention;

FIG. 7 is a flowchart of the detection method according to one embodiment of the present invention; and

FIG. 8 is a flowchart of the detection method according to another embodiment of the present invention.

### DETAILED DESCRIPTION OF THE INVENTION

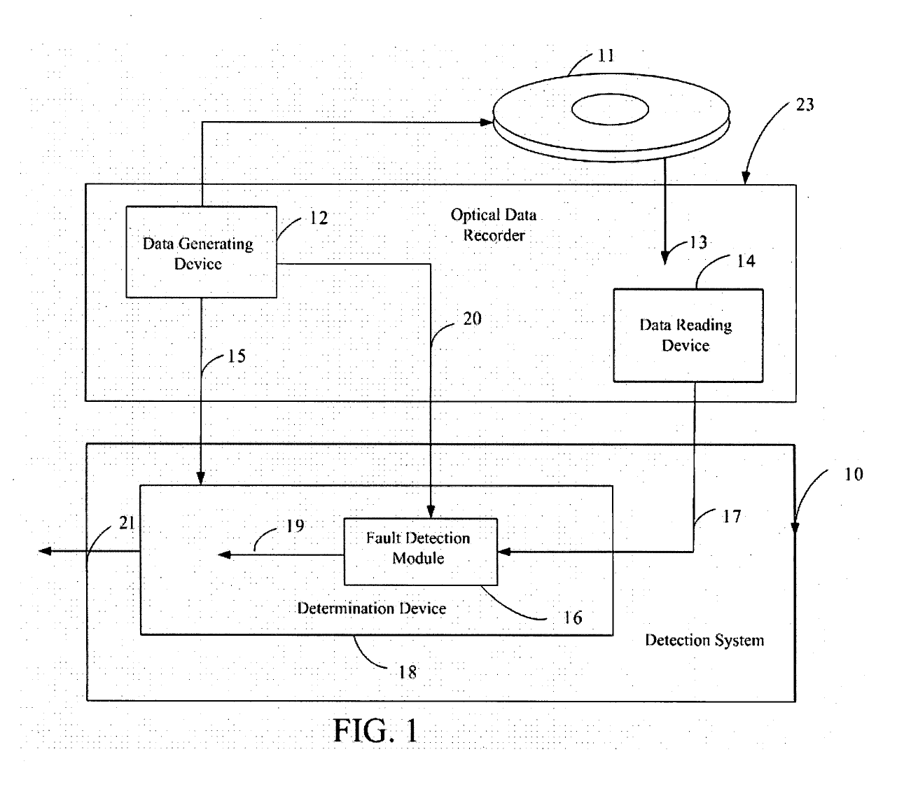

Referring to FIG. 1, FIG. 1 is a functional block diagram of a detection system 10 according to the present invention. When recording data onto an optical data storage medium 11 which includes a fault correction mechanism (also called a error correction mechanism), the detection system 10 of the present invention reads a reflection signal 13 from the optical data storage medium 11 to detect and/or confirm whether the recorded data can be reliably read out under the fault correction mechanism. The detection system 10 comprises mainly a determination device 18. In a preferred embodiment of the present invention, the detection system 10 is coupled to an optical data recorder 23. The optical data recorder 23 may comprise a data generating device 12 and a data reading device 14. In other embodiments, in addition to the determination device 18, the detection system 10 may optionally comprise a data generating device 12 and/or a data reading device 14. The determination device 18 of the present invention further comprises a fault detection module 16.

The data generating device 12 generates data to be recorded, and outputs a data synchronization signal 15 that synchronizes with the recorded data. The data reading device 14 reads the reflection signal 13 and generates a read-out signal 17 to the determination device 18. In one preferred embodiment, the read-out signal 17 is a radio frequency (RF) signal. The fault detection module 16 of the determination device 18 receives the read-out signal 17 from the data reading device 14 and a write data signal 20 from the data generating device 12, then generates and outputs a write fault signal 19. In an actual circuit, for example, the data generating device 12 can be an encoder often used in an optical recording system. The determination device 18 can be a decoder often used in the optical recording system. According to the purpose of the present invention, the determination device 18 is not necessarily a decoder with full decoding functions. It would serve the invention purpose as long as the determination device 18 can make determinations or judgments based on the rules of the fault correction mechanism, and output corresponding error signals. For example, the determination device 18 of the present invention may be a decoder with only partial or simplified decoding functions. In other words, the simplified decoder of the determination device 18 does not have to possess actual decoding functions or actually perform decoding operations. It will be sufficient that such decoder can count the fault (or called error) number found in one error correction code (ECC) block of read-out data. When the fault number is larger than a predetermined threshold, a defect has occurred in the process of recording data onto the optical data storage medium 11. The write fault signal 19 is correspondingly generated as a notice signal.

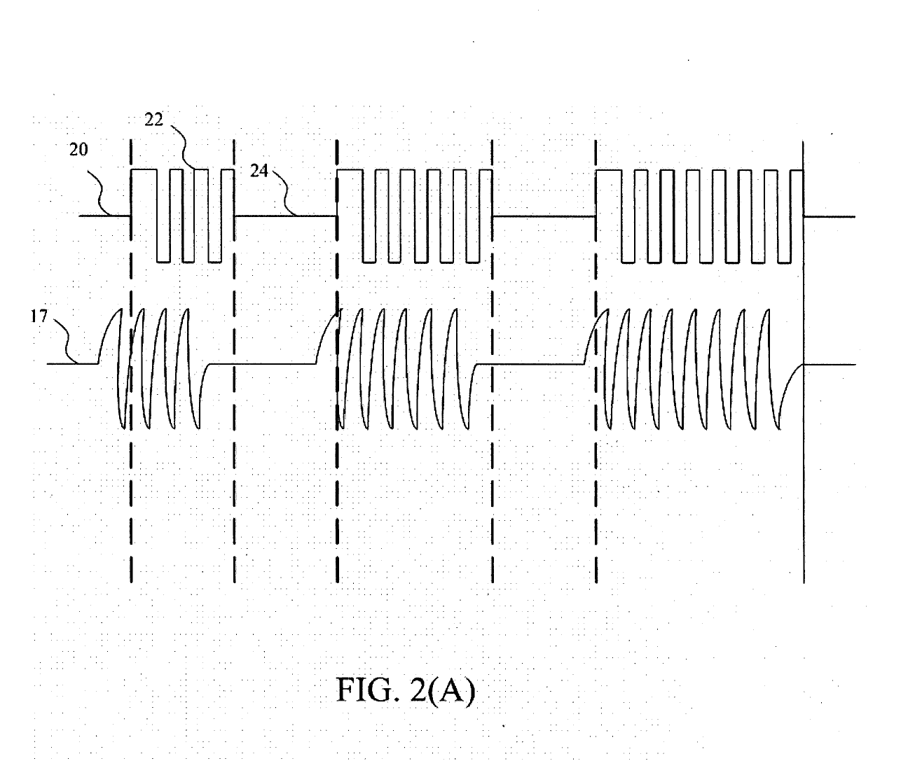

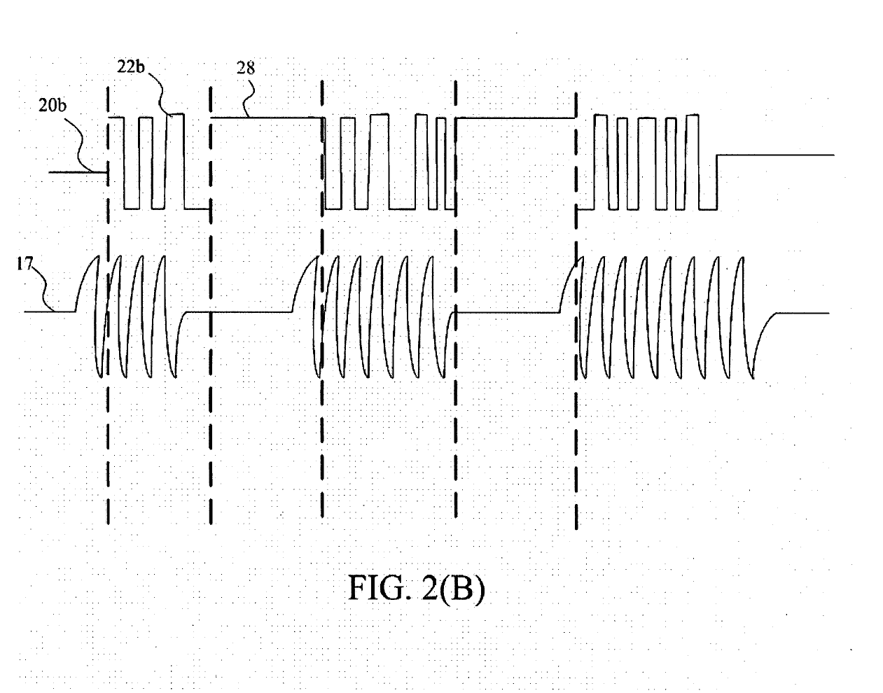

Referring to FIG. 2(A), FIG. 2(A) is a schematic diagram of one kind of write fault signal 19 generated by the detection system 10 shown in FIG. 1. In a preferred embodiment, the fault detection module 16 receives the write data signal 20 from the data generating device 12. The write data signal 20 comprises a plurality of pit patterns 22 and land patterns 24. The fault detection module 16 generates the write fault signal 19 according to a level of the read-out signal 17 when the write data signal 20 is of the pit patterns 22.

Referring to FIG. 2(B), FIG. 2(B) is a schematic diagram of another kind of write fault signal 19 generated by the detection system 10 shown in FIG. 1. In a preferred embodiment, the fault detection module 16 receives a write data signal 20b from the data generating device 12. The write data signal 20b comprises a plurality of pit patterns 22b and land patterns 28. The fault detection module 16 generates the write fault signal 19 according to a level of the read-out signal 17 when the write data signal 20b is of the land patterns 28. In the embodiments shown in FIG. 2(A) and FIG. 2(B), the write data signal 20 and 20b are different forms of signals, and the write fault signal 19 is generated to determine whether the read-out signal 17 has occurred error.

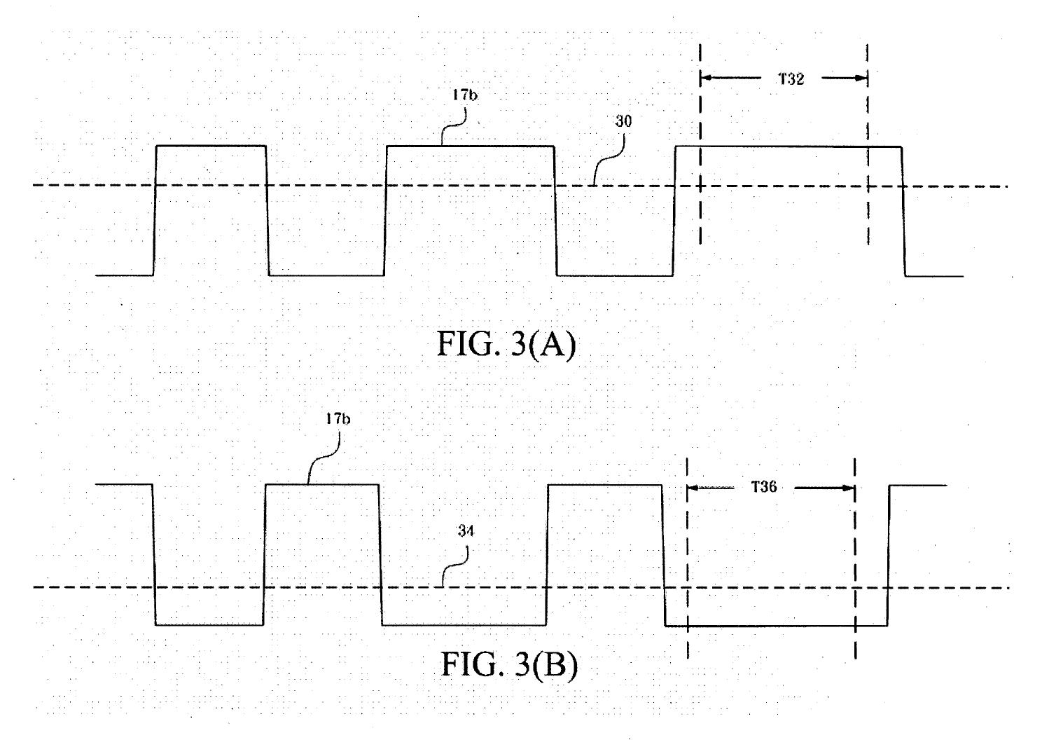

Referring to FIG. 3(A) and FIG. 3(B), FIG. 3(A) is a schematic diagram of one kind of the write fault signal 19 generated in different manners based on the read-out signal 17b by the detection system 10 shown in FIG. 1, and FIG. 3(B) is a schematic diagram of another kind of the write fault signal 19 generated in different manners based on the read-out signal 17b by the detection system 10 shown in FIG. 1. In different embodiments, the write fault signal 19 can be generated by various means. In the embodiment shown in FIG. 3(A), the write fault signal 19 is generated by the fault detection module 16 based on whether a sustaining time period of the read-out signal 17b is longer than a first length threshold (T32). The sustaining time period means a time period during which a level of the read-out signal is higher than a first level threshold 30. If the sustaining time period is longer than T32, it means there is an error occurring during data recording process, and then the write fault signal 19 is generated. In one embodiment, the first length threshold (T32) is larger than or equal to a maximum run-length in a modulation rule of the recorded data.

In the embodiment as shown in FIG. 3(B), the write fault signal 19 is generated by the fault detection module 16 based on whether a sustaining time period is longer than a second length threshold (T36). The sustaining time period means a time period during which a level of the read-out signal 17b is lower than a second level threshold 34. If the sustaining time period is longer than T36, it means there is an error occurring during data recording process, and the write fault signal 19 is generated. In one embodiment, the second length threshold (T36) is larger than or equal to a maximum run-length in a modulation rule of the recorded data.

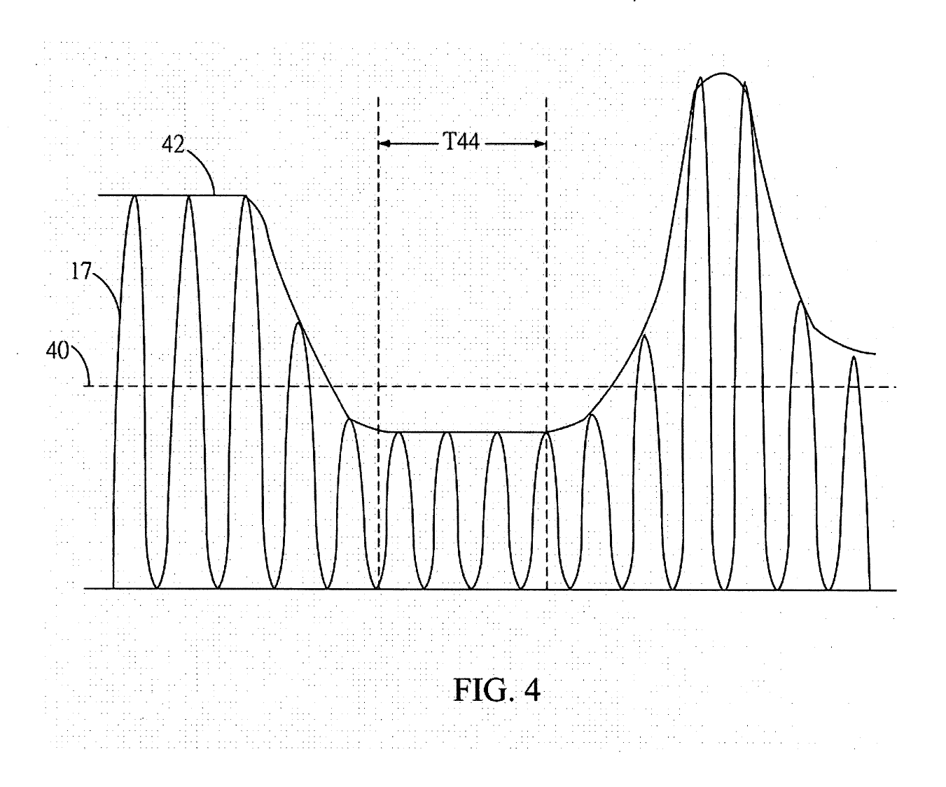

Referring to FIG. 4, FIG. 4 is a schematic diagram of another kind of the write fault signal 19 generated based on the read-out signal 17c by the detection system 10 shown in FIG. 1. In this embodiment, the fault detection module 16 makes determinations based on an envelop value 42 of the read-out signal 17c and a threshold 40. When the envelop value 42 is sustaining higher or lower than the threshold 40 for a predetermined time period T44, the write fault signal 19 is generated and outputted. In the embodiment shown in FIG. 4, the envelop value 42 is the value of the curve by connecting all the adjoining peaks of the read-out signal 17c. In this manner, the read-out signal 17c originally having more cycles is converted into a signal having fewer cycles. This can facilitate the determination of whether the read-out signal 17c has any errors.

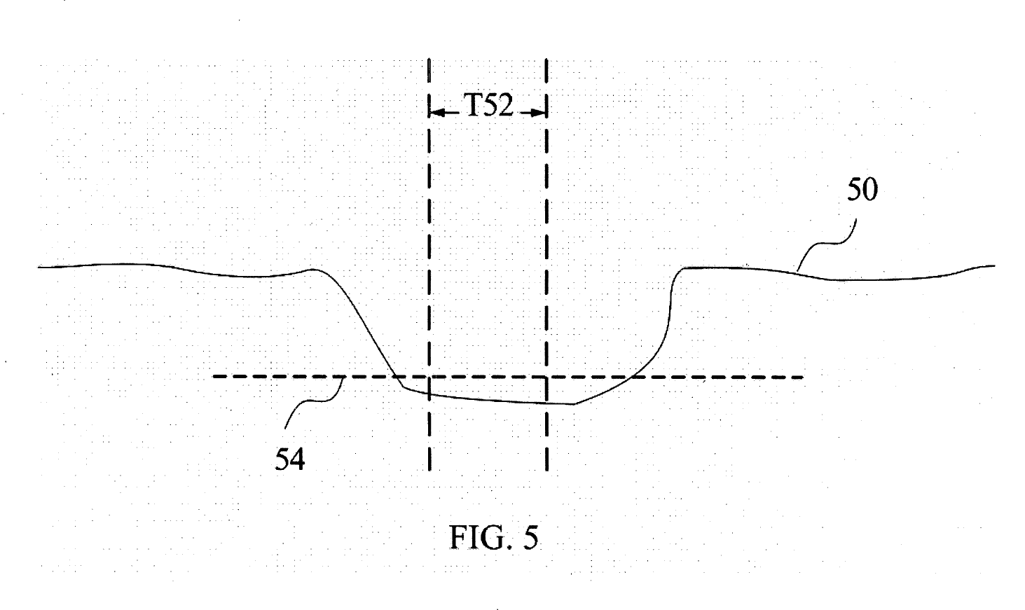

FIG. 5 is a schematic diagram of another kind of the write fault signal 19 generated based on another read-out signal by the detection system 10 shown in FIG. 1. In the embodiment shown in FIG. 5, the read-out signal is a sub-beam added (SBAD) signal 50 and the fault detection module 16 makes a comparison between the signal level of the SBAD signal 50 and a third level threshold T52. As shown in FIG. 5, when the waveform of the SBAD signal 50 is sustaining lower than the signal level 54 for a predetermined time period (i.e. the third level threshold T52), the write fault signal 19 is generated and outputted by the fault detection module 16.

In one embodiment, the write fault signal indicates whether the area for recording the recorded data is a defect area. In another embodiment, the write fault signal indicates whether a wear-out effect has occurred in the area for recording the recorded data due to multiple readings and writings.

The following description is focused on the follow-ups of the detection system 10 after the fault detection module 16 has generated the write fault signal 19. As shown in FIG. 1, after the fault detection module 16 generates the write fault signal 19, the determination device 18 outputs a faulted data information signal 21 based on rules of the fault correction mechanism, the write fault signal 19 and the data synchronization signal 15. While recording data, the data generating device 12 also generates the data synchronization signal 15 to the determination device 18. The data synchronization signal 15 comprises a fault correction block synchronization signal (not shown) that synchronizes with an ECC (error correction code) block of the recorded data. Then, based on this fault correction block synchronization signal, the determination device 18 can determine the faulted area of the recorded data on the optical data storage medium 11. After the faulted area is identified, the faulted data detected by the aforementioned manner can be recorded on the spare area of the optical data storage medium 11. Therefore, when the recorded data on the faulted area of the optical data storage medium 11 are to be accessed, the correct recorded data in the spare area will instead be accessed and read out according to the information recorded in the data synchronization signal 15.

In one embodiment, the data synchronization signal 15 comprises a sector synchronization signal that synchronizes with a sector of the recorded data. In another embodiment, the data synchronization signal 15 comprises a frame synchronization signal. In these embodiments, the sector synchronization signal and the frame synchronization signal are used to facilitate the determination when data error occurs. The faulted area is recorded and the correction operation of the data recording is followed.

In another embodiment, the determination device 18 further comprises a first memory device for storing a sector identification information of the recorded data as a faulted sector identification information after the faulted data information signal 21 is enabled. The faulted sector identification information is utilized for identifying the faulted sector of the recorded data. With this information, the faulted area of the recorded data can be identified if an error occurs during data recording and the correction operation of the data recording can be pursued. In this manner, the data can be recorded onto the optical data storage medium 11 completely and correctly.

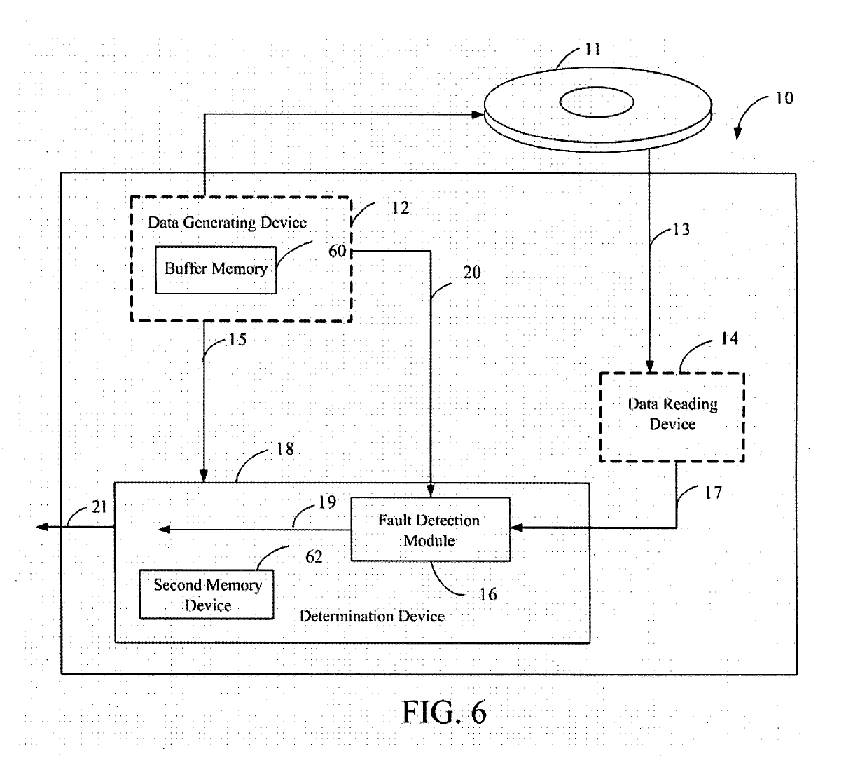

Referring to FIG. 6, FIG. 6 is a schematic diagram of the buffer memory of the data generating device according to the present invention. In this embodiment, the detection system 10 may optionally comprise a data generating device 12 and/or a data reading device 14. The data generating device 12 and the data reading device 14, which are illustrated in dotted lines, can also belong to another independent optical data recorder. The data generating device 12 comprises a buffer memory 60 for buffering the recorded data. The determination device 18 further comprises a second memory device 62. After the faulted data information signal is enabled, the second memory device 62 can store a storing address of the recorded data stored in the buffer memory 60 as a faulted buffer memory address. When data recording error occurs, the correction operation of the data recording can be pursued according to the faulted buffer memory address and the data temporarily recorded in the buffer memory 60. And the data can be correctly re-written in the spare area of the optical data storage medium 11. Therefore, after the data recording is completed, the recorded data can be read out in a complete and correct manner when accessing the recorded data.

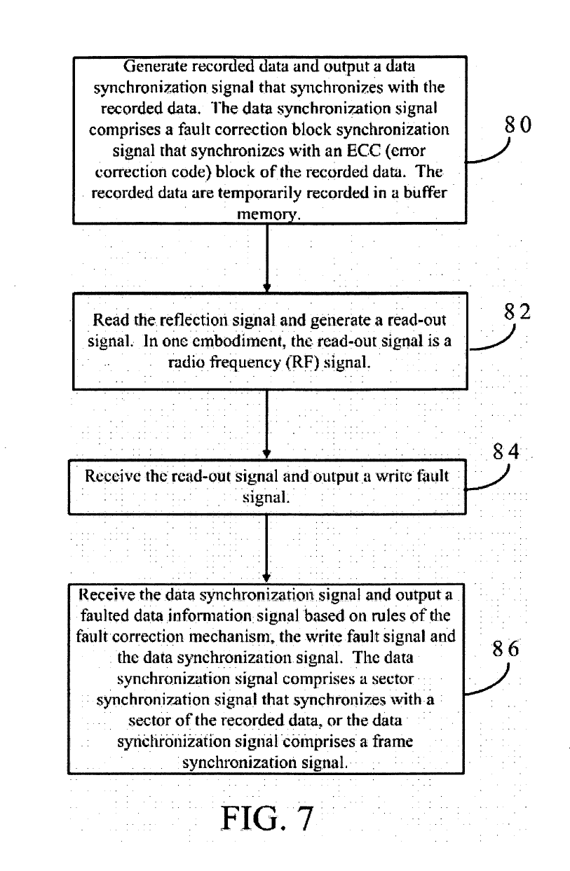

Referring to FIG. 7, FIG. 7 is a flowchart of a detection method according to one embodiment of the present invention. When recording data onto an optical data storage medium which includes a fault correction mechanism, the detection method reads a reflection signal from the optical data storage medium. Making a determination of the reflection signal based on rules of the fault correction mechanism, and outputting a faulted data information signal accordingly. In this manner, it can be detected and ensured that the recorded data can be reliably read out under the fault correction mechanism. The detection method is described detailed in the following steps.

S80: Generating recorded data and outputting a data synchronization signal that synchronizes with the recorded data. The data synchronization signal comprises a fault correction block synchronization signal that synchronizes with an ECC (error correction code) block of the recorded data. The recorded data are temporarily recorded in a buffer memory.

S82: Reading the reflection signal and generating a read-out signal. In one embodiment, the read-out signal is a radio frequency (RF) signal.

S84: Receiving the read-out signal and outputting a write fault signal.

S86: Receiving the data synchronization signal and outputting a faulted data information signal based on rules of the fault correction mechanism, the write fault signal and the data synchronization signal. In one embodiment, the data synchronization signal comprises a sector synchronization signal that synchronizes with a sector of the recorded data. In another embodiment, the data synchronization signal comprises a frame synchronization signal.

In different embodiments, Step S84 can be implemented differently. In one embodiment, receiving a write data signal in S84, the write data signal comprises a plurality of pit patterns and land patterns. And generating a write fault data signal according to a level of the read-out signal when the write data signal is of the pit patterns. In another embodiment, a write data signal received in S84 comprises a plurality of pit patterns and land patterns. And generating a write fault signal according to a level of the read-out signal when the write data signal is of the land patterns.

In different embodiments, the write fault signal in S84 can be generated by different implementations. In one embodiment, generating the write fault signal based on whether a sustaining time period of the read-out signal is longer than a first length threshold. The sustaining time period means a time period during which the signal level of the read-out signal is higher than a first level threshold. And the first length threshold is larger than or equal to a maximum run-length in a modulation rule of the recorded data. In another embodiment, generating the write fault signal based on whether a sustaining time period is longer than a second length threshold. The sustaining time period means a time period during which the signal level of the read-out signal is lower than a second level threshold. And the second length threshold is larger than or equal to a maximum run-length in a modulation rule of the recorded data. In yet another embodiment, the write fault signal is generated based on an envelop value of the read-out signal.

In yet another embodiment, the read-out signal is a sub-beam added (SBAD) signal. Generating and outputting the write fault signal based on a comparison result between the signal level of the SBAD signal and a third level threshold in step S84.

In different embodiments, the step S86 can be implemented differently. In one embodiment, S86 can further comprise the following step: after enabling the faulted data information signal, storing a sector identification information of the recorded data as a faulted sector identification information. In another embodiment, S86 can further comprise the following step: after enabling the faulted data information signal, storing a storing address of the recorded data stored in the buffer memory as a faulted buffer memory address.

In one embodiment, the write fault signal means whether the data recorded area is a defect area. In another embodiment, the write fault signal indicates whether a wear-out effect has occurred in the area for recording the recorded data due to multiple readings and writings.

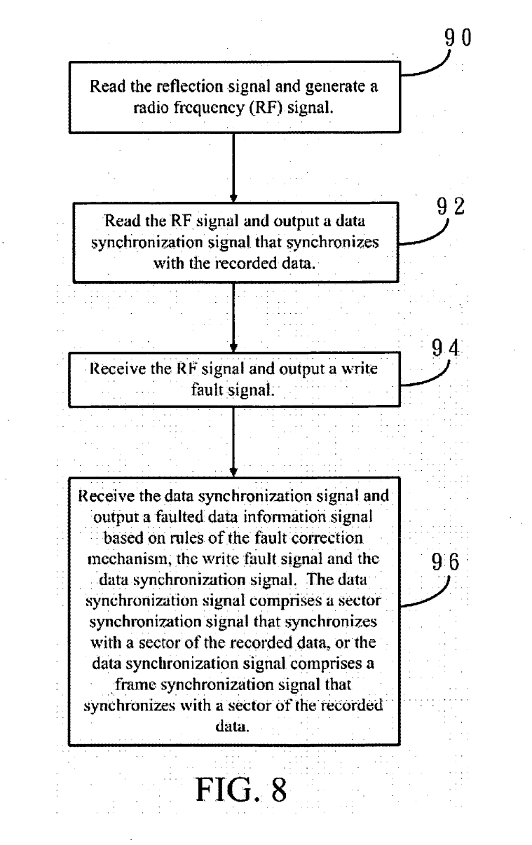

Referring to FIG. 8, FIG. 8 is a flowchart of a detection method according to another embodiment of the present invention. When recording a data onto an optical data storage medium where a fault correction mechanism is included, the detection method reads a reflection signal from the optical data storage medium. In this manner, it can be detected and ensured that the recorded data can be reliably read out under the fault correction mechanism. As shown in FIG. 8, the detection method of this embodiment comprises the following steps:

S90: Reading the reflection signal and generating a radio frequency (RF) signal;

S92: Reading the RF signal and outputting a data synchronization signal that synchronizes with the recorded data;

S94: Receiving the RF signal and outputting a write fault signal; and

S96: Receiving the data synchronization signal and outputting a faulted data information signal based on rules of the fault correction mechanism, the write fault signal and the data synchronization signal. In one embodiment, the data synchronization signal comprises a sector synchronization signal that synchronizes with a sector of the recorded data. In another embodiment, the data synchronization signal comprises a frame synchronization signal that synchronizes with a sector of the recorded data.

In different embodiments, Step S94 can be implemented differently. In one embodiment, receiving a write data signal firstly, wherein the write data signal comprises a plurality of pit patterns and land patterns, and then generating a write fault signal according to a level of the read-out signal when the write data signal is of the pit patterns. In another embodiment, receiving a write data signal firstly, wherein the write data signal comprises a plurality of pit patterns and land patterns, and then generating a write fault signal according to a level of the read-out signal when the write data signal is of the land patterns.

In step S94, in yet another embodiment, generating the write fault signal based on whether a sustaining time period of the read-out signal is longer than a first length threshold. The sustaining time period means a time period during which a level of the read-out signal is higher than a first level threshold. The first length threshold is larger than or equal to a maximum run-length in a modulation rule of the recorded data.

In step S94, in still another embodiment, generating the write fault signal based on whether a sustaining time period is longer than a second length threshold. The sustaining time period means a time period during which a level of the read-out signal is lower than a second level threshold. The second length threshold is larger than or equal to a maximum run-length in a modulation rule of the recorded data.

By directly reading the reflection signal from the optical data storage medium during data recording process, the detection system of the present invention can real-time detect the authenticity of the recorded data. In comparison with the prior-art, the present invention can save the task and time for “read verify” check. Therefore, by applying detection system and method of the present invention in data recording, it can save the time required for the entire data recording. Furthermore, the RF signal rendered during the data recording process can be used for determining whether the recorded data are reliable. The detection system and method of the present invention can improve the efficiency and quality of the data recording.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A detection system, when recording data onto an optical data storage medium which includes a fault correction mechanism, reads a reflection signal from the optical data storage medium for detecting whether the recorded data can be reliably read out under the fault correction mechanism, the detection system comprising:
a determination device for outputting a faulted data information signal in response to the reflection signal based on rules of the fault correction mechanism.

2. The system of claim 1, wherein the determination device outputs the faulted data information signal further based on a data synchronization signal that synchronizes with the recorded data.

3. The system of claim 2, wherein the detection system is coupled to an optical data recorder, the optical data recorder comprises:
a data generating device for generating the recorded data; and
a data reading device for reading the reflection signal and generating a read-out signal to the determination device.

4. The system of claim 3, wherein the read-out signal is a radio frequency (RF) signal and the detection system further comprises a synchronization detection device for reading the RF signal and outputting the data synchronization signal.

5. The system of claim 3, wherein the data generating device generates the data synchronization signal based on the recorded data.

6. The system of claim 3, wherein the data reading device generates the data synchronization signal based on the reflection signal.

7. The system of claim 3, wherein the determination device comprises:
a fault detection module for receiving the read-out signal and outputting a write fault signal as the faulted data information signal.

8. The system of claim 7, wherein the fault detection module receives a write data signal from the data generating device and the write data signal comprises a plurality of pit patterns and land patterns, and wherein the write fault signal is generated according to a level of the read-out signal when the write data signal is of the pit patterns.

9. The system of claim 7, wherein the fault detection module outputs the write fault signal based on an envelop value of the read-out signal.

10. The system of claim 7, wherein the read-out signal is a sub-beam added (SBAD) signal and the fault detection module outputs the write fault signal based on a comparison result between a level of the read-out signal and a third level threshold.

11. A detection method, when recording data onto an optical data storage medium which includes a fault correction mechanism, for detecting whether the recorded data can be reliably read out under the fault correction mechanism, the detection method comprising:
(a) reading a reflection signal from the optical data storage medium while recording the data; and
(b) outputting a faulted data information signal in response to the reflection signal based on rules of the fault correction mechanism.

12. The method of claim 11, further comprising:
(a1) generating the recorded data and outputting a data synchronization signal that synchronizes with the recorded data;
(a2) reading the reflection signal and generating a read-out signal;
(b1) receiving the read-out signal and outputting a write fault signal; and
(b2) receiving the data synchronization signal, and outputting a faulted data information signal based on rules of the fault correction mechanism, the write fault signal and the data synchronization signal.

13. The method of claim 12, wherein the read-out signal is a sub-beam added (SBAD) signal and the step (b1) outputs the write fault signal based on a comparison result between a level of the read-out signal and a third level threshold.

14. The method of claim 12, wherein the data synchronization signal comprises a fault correction block synchronization signal that synchronizes with an ECC (error correction code) block of the recorded data.

15. The method of claim 12, wherein the data synchronization signal comprises a sector synchronization signal that synchronizes with a sector of the recorded data.

16. The method of claim 12, wherein the data synchronization signal comprises a frame synchronization signal.

17. The method of claim 12, wherein the step (b2) further comprises:
after enabling the faulted data information signal, storing a storing address of the recorded data stored in the buffer memory as a faulted buffer memory address.

18. A detection method, when recording data onto an optical data storage medium which includes a fault correction mechanism, for reading a reflection signal from the optical data storage medium to detect whether the recorded data can be reliably read out under the fault correction mechanism, the detection method comprising:
(I) reading the reflection signal and generating a radio frequency (RF) signal;
(II) reading the reflection signal and outputting a data synchronization signal that synchronizes with the recorded data;
(III) receiving the RF signal and outputting a write fault signal; and
(IV) receiving the data synchronization signal, and outputting a faulted data information signal based on rules of the fault correction mechanism, the write fault signal and the data synchronization signal.

19. The method of claim 18, wherein the step (III) further comprises:
receiving a write data signal which comprises a plurality of pit patterns and land patterns; and
outputting the write fault signal according to a level of the RF signal when the write data signal is of the pit patterns.

20. The method of claim 18, wherein the step (III) further comprises:
receiving a write data signal which comprises a plurality of pit patterns and land patterns; and
outputting the write fault signal according to a level of the RF signal when the write data signal is of the land patterns.
